(19) United States
(12) Patent Application Publication
(10) Pub. No.: US 2026/0122058 A1
(43) Pub. Date: Apr. 30, 2026

(54) SYSTEM AND METHOD FOR AUTOMATED AUTHENTICATION

(71) Applicant: ROYAL BANK OF CANADA, Toronto (CA)

(72) Inventors: Marissa G. COLACITTI, Toronto (CA); Kendall E. W. ROWE, Toronto (CA)

(21) Appl. No.: 19/370,191

(22) Filed: Oct. 27, 2025

Related U.S. Application Data
(60) Provisional application No. 63/713,530, filed on Oct. 29, 2024.

(51) Int. Cl. H04L 9/40; G06Q 10/107

(52) U.S. Cl. CPC H04L 63/083; G06Q 10/107; H04L 2463/082

(57) ABSTRACT

There is provided a method and system for automating a user authentication process. A server assigns an access request for a service from a user to a computer-implemented worker agent. The agent may store a current verification code value prior to performing the access request. The agent may be programmed to perform various operations at a login screen for the service. Upon requesting a verification code, the contents of a verification message are forwarded to a server configured to retrieve and store the verification code. The worker may poll a memory location storing the most recently received verification code until the previously stored verification code is different from the contents of the memory location. The worker may enter the newly received code into an authentication window and complete the authentication process using the verification code.

### CROSS-REFERENCE TO RELATED APPLICATIONS

This claims the benefit of, and priority to, U.S. Provisional Patent Application No. 63/713,530, filed October 29, 2024, the entire contents of which are incorporated herein by reference.

### FIELD

This disclosure relates to authentication, and in particular to automatic authentication systems and methods.

### BACKGROUND

As the risk of cyber security threats increases, the use of various advanced authentication techniques beyond conventional techniques, such as passwords, has become commonplace. Many online services require more than simply entering a password in order for a legitimate user to gain access. The use of techniques such as 2-factor authentication and multi-factor authentication (referred to herein as “MFA”) (e.g., the granting of access only after successfully presenting two or more pieces of evidence to an authentication mechanism) has provided enhanced security, but may nevertheless be cumbersome in its application in various contexts.

There is a need for authentication systems and methods which can streamline the authentication process while incorporating the security advantages of MFA techniques. It would be beneficial to reduce and/or obviate the inconvenience and practical challenges which frequently arise when attempting to gain access to a system making use of MFA techniques.

### SUMMARY

According to an aspect, there is provided a method of authenticating a user, the method comprising: providing a database having a memory location for storing a verification code; receiving, at a server, a request to access a service requiring multi-factor authentication; generating, by said server, a request message based on said request to access said service; assigning said request message to a first worker agent; obtaining and storing, by said first worker agent, an initial verification code from said memory location of said database; requesting, by said first worker agent, access to said service at a login page of said service, said access request comprising an email address; detecting receipt of a message at said email address, said message including a current verification code; determining, by said server, whether said message contains a verification code for said service; in response to determining that said message contains said verification code for said service, storing, by said server, said current verification code in said memory location of said database; obtaining, by said first worker agent, said current verification code from said memory location of said database; entering, by said first worker agent, said current authentication code in a field of said login page; and transmitting, by said first worker agent, said current verification code to gain access to said service.

According to another aspect, there is provided a system comprising: one or more processors; and a computer-readable storage medium having stored thereon computer-executable instructions that, when executed by said one or more processors, cause said one or more processors to perform a method of authenticating a user, the method comprising: providing a database having a memory location for storing a verification code; receiving, at a server, a request to access a service requiring multi-factor authentication; generating, by said server, a request message based on said request to access said service; assigning said request message to a first worker agent; obtaining and storing, by said first worker agent, an initial verification code from said memory location of said database; requesting, by said first worker agent, access to said service at a login page of said service, said access request comprising an email address; detecting receipt of a message at said email address, said email address, said message including a current verification code; determining, by said server, whether said verification message contains a verification code; in response to determining that said message contains said verification code, storing, by said server, said current verification code in said memory location of said database; obtaining, by said first worker agent, said current verification code from said memory location of said database; entering, by said first worker agent, said current authentication code in a field of said login page; and transmitting, by said first worker agent, said current verification code to gain access to said service.

According to still another aspect, there is provided a non-transitory computer-readable storage medium having stored thereon computer-executable instructions that, when executed by one or more processors, cause said one or more processors to perform a method of authenticating a user, the method comprising: providing a database having a memory location for storing a verification code; receiving, at a server, a request to access a service requiring multi-factor authentication; generating, by said server, a request message based on said request to access said service; assigning said request message to a first worker agent; obtaining and storing, by said first worker agent, an initial verification code from said memory location of said database; requesting, by said first worker agent, access to said service at a login page of said service, said access request comprising an email address; detecting receipt of a message at said email address, said message including a current verification code; determining, by said server, whether said verification message contains a verification code; in response to determining that said message contains said verification code, storing, by said server, said current verification code in said memory location of said database; obtaining, by said first worker agent, said current verification code from said memory location of said database; entering, by said first worker agent, said current verification code in a field of said login page; and transmitting, by said first worker agent, said current verification code to gain access to said service.

Other features will become apparent from the drawings in conjunction with the following description.

### BRIEF DESCRIPTION OF DRAWINGS

In the figures which illustrate example embodiments,

FIG. 1 is a block diagram depicting components of an example computing system, in accordance with some embodiments;

FIG. 2 is a block diagram depicting components of an example computing device, in accordance with some embodiments;

FIG. 3 depicts a simplified arrangement of software at computing device, in accordance with some embodiments;

FIG. 4 depicts an example graphical user interface of a login page for a service, in accordance with some embodiments;

FIG. 5A depicts an example user interface containing a verification prompt presented to the user during a login attempt, in accordance with some embodiments;

FIG. 5B depicts an example user interface containing a field for entering a verification or authentication code, in accordance with some embodiments;

FIG. 6 depicts an example message containing a verification code, in accordance with some embodiments; and

FIG. 7 is a block diagram depicting logical components of an example automated authentication system, in accordance with some embodiments.

### DETAILED DESCRIPTION

Some embodiments described herein may relate to a system which facilitates authentication when attempting to gain access to a system which uses multi factor authentication (MFA). In particular, some embodiments relate to web automations for logging into services using MFA. Some embodiments may automate the process of requesting, receiving, and processing of messages which contain time-limited codes used for authentication purposes.

Some embodiments may be particularly advantageous when used in conjunction with MFA systems which rely on email as an authentication mechanism (e.g., an email containing a time-sensitive authentication or verification code may be sent to the user’s email address, after a registered username and associated password have been correctly entered). Moreover, some embodiments described herein may be particularly advantageous in scenarios in which the third party has not made an application programming interface (API) available for directly interfacing with the third party services, thus requiring the use of manual web authentication.

Frequently, there is a temporal delay between a login attempt and the eventual receipt of the email which contains the verification code. Often, this delay may be sufficiently long to be disruptive to productivity, as a user is typically sitting idle while waiting for the code-containing email to appear. Often, the arrival of the verification email may be significantly delayed due to cybersecurity systems at the recipient which must first process and assess the authentication email for potential threats and risks prior to allowing the email to be sent to the user’s inbox.

Such delays may be sufficiently long that a login page may time out after a certain amount of time has elapsed after the login attempt was initiated, thereby requiring the user to re-start the login process. Moreover, some login pages or portals configured to receive the verification code might not have a unique website address or uniform resource locator (URL) associated therewith, which means that a particular login session page must remain open within a browser once initiated, and cannot be retrieved or re-opened if closed or otherwise navigated away from. This may result in users opening additional web browser windows or tabs, which increases memory usage and makes it harder for the user to find their way back to the login portal page before the authentication process times out.

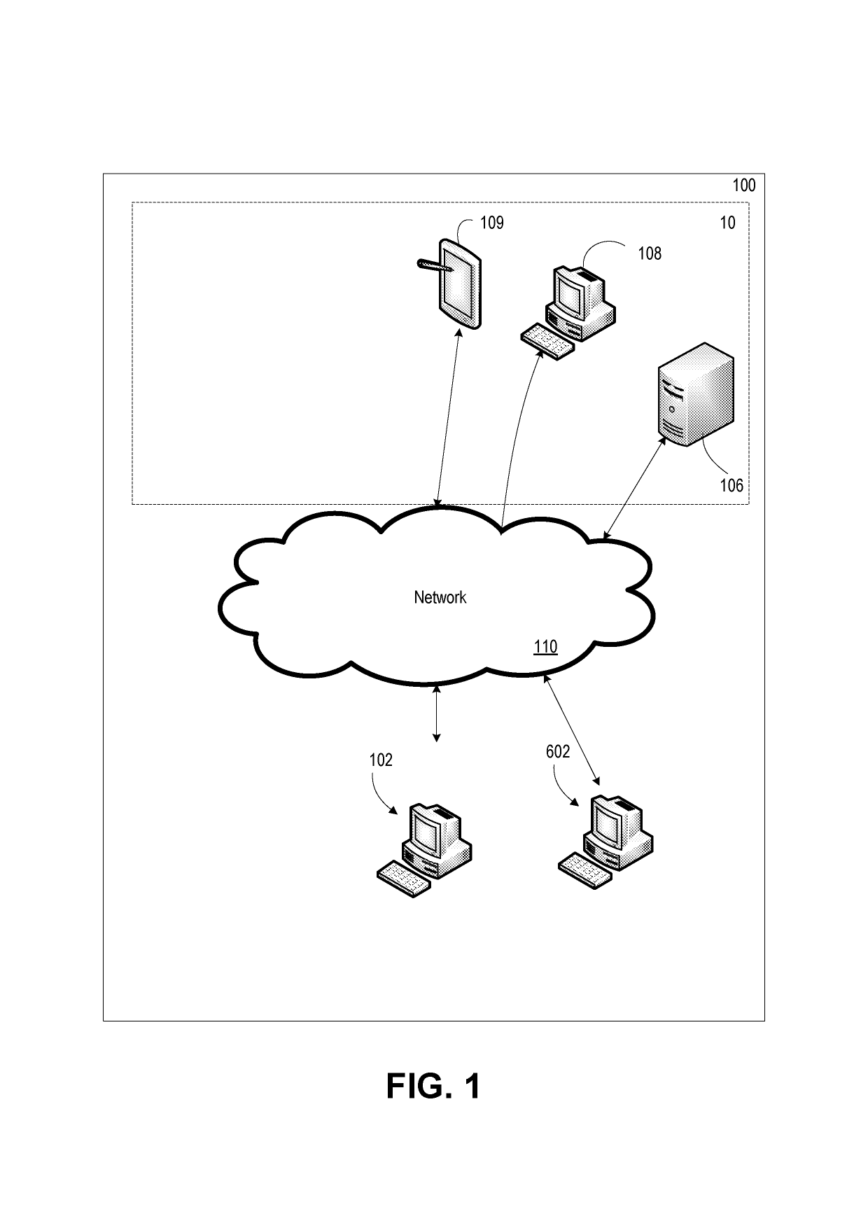

Various embodiments described herein make use of interconnected computer networks and computing components. FIG. 1 is a block diagram depicting components of an example computing system 100. As depicted, the system 100 includes a variety of clients incorporating and/or incorporated into a variety of computing devices 102 which may communicate with other computing devices 102 via one or more networks 110, such as the internet. For example, a client 102 may incorporate and/or be incorporated into client application implemented at least in part by one or more computing devices.

Example computing devices may include, for example, at least one server 102 with a data storage 118 such as a hard drive, an array of hard drives, network-accessible storage, or the like; at least one web server 106, and a plurality of client computing devices 108. Server 102, web server 106, and client computing devices 108 may be in communication by way of a network 110. More or fewer of each device are possible relative to the example configuration depicted in FIG. 1. In some embodiments, one or more computing devices may be logically internal to an organization 10 (depicted in FIG. 1 as devices 102, 109, 108 and 106 being internal to organization 10).

Network 110 may include one or more local-area networks or wide-area networks, such as IPv4, IPv6, X.25, IPX compliant, or similar networks, including one or more wired or wireless access points. The networks may include one or more local-area networks (LANs) or wide-area networks (WANs), such as the internet. In some embodiments, the networks are connected with other communications networks, such as GSM/GPRS/3G/4G/LTE/5G networks.

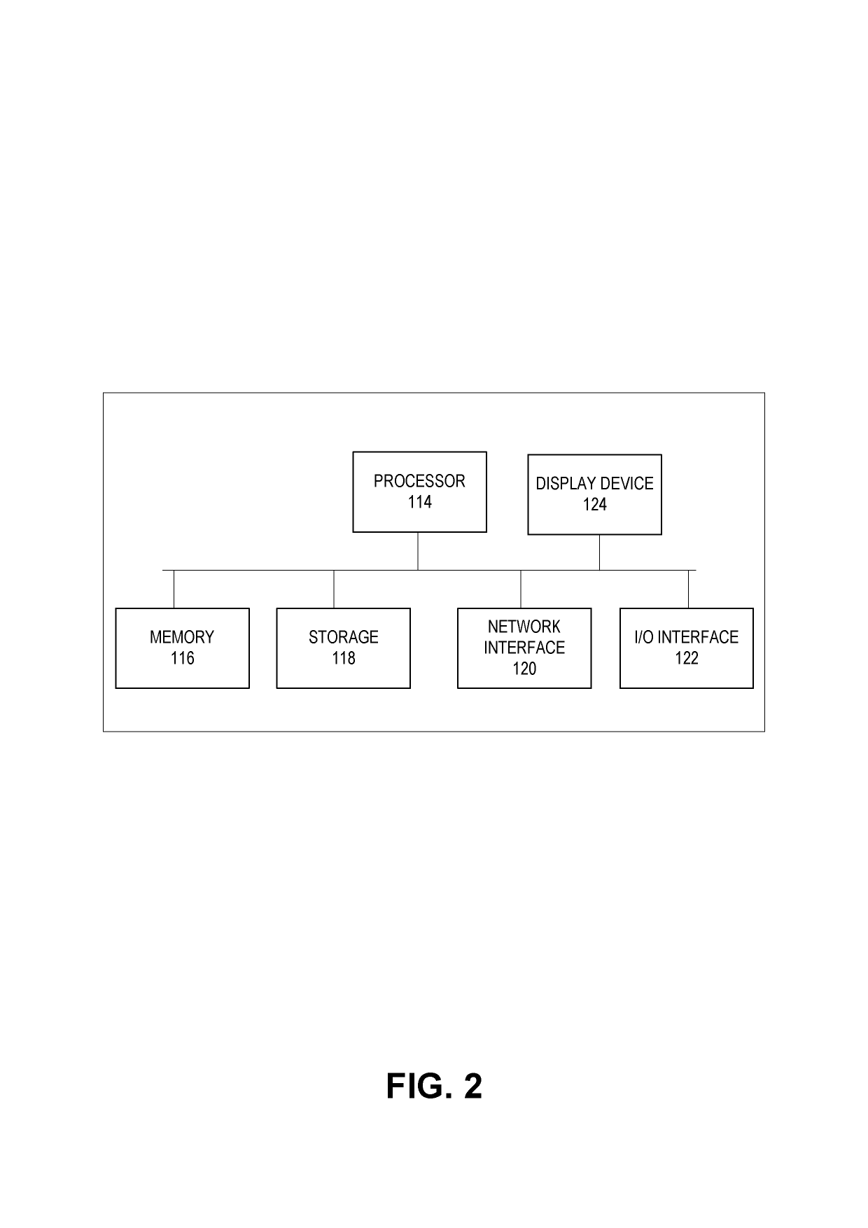

FIG. 2 is a block diagram depicting components of an example computing device, such as a desktop computing device 102, client computing device 108, tablet 109, mobile computing device, and the like. As depicted, an example computing device may include a processor 114, memory 116, persistent storage 118, network interface 120, and input/output interface 122.

Processor 114 may be an Intel or AMD x86 or x64, PowerPC, ARM processor, or the like. Processor 114 may operate under the control of software loaded in memory 116. Network interface 120 connects the computing device to network 110. Network interface 120 may support domain-specific networking protocols for certain peripherals or hardware elements. I/O interface 122 connects the computing device to one or more storage devices and peripherals such as keyboards, mice, pointing devices, USB devices, disk drives, display devices 124, and the like.

In some embodiments, I/O interface 122 may connect various hardware and software devices used in connection with the systems and methods described herein to processor 114 and/or to other computing devices. In some embodiments, I/O interface 122 may be compatible with protocols such as WiFi, Bluetooth, and other communication protocols.

Software may be loaded onto one or more computing devices. Such software may be executed using processor 114.

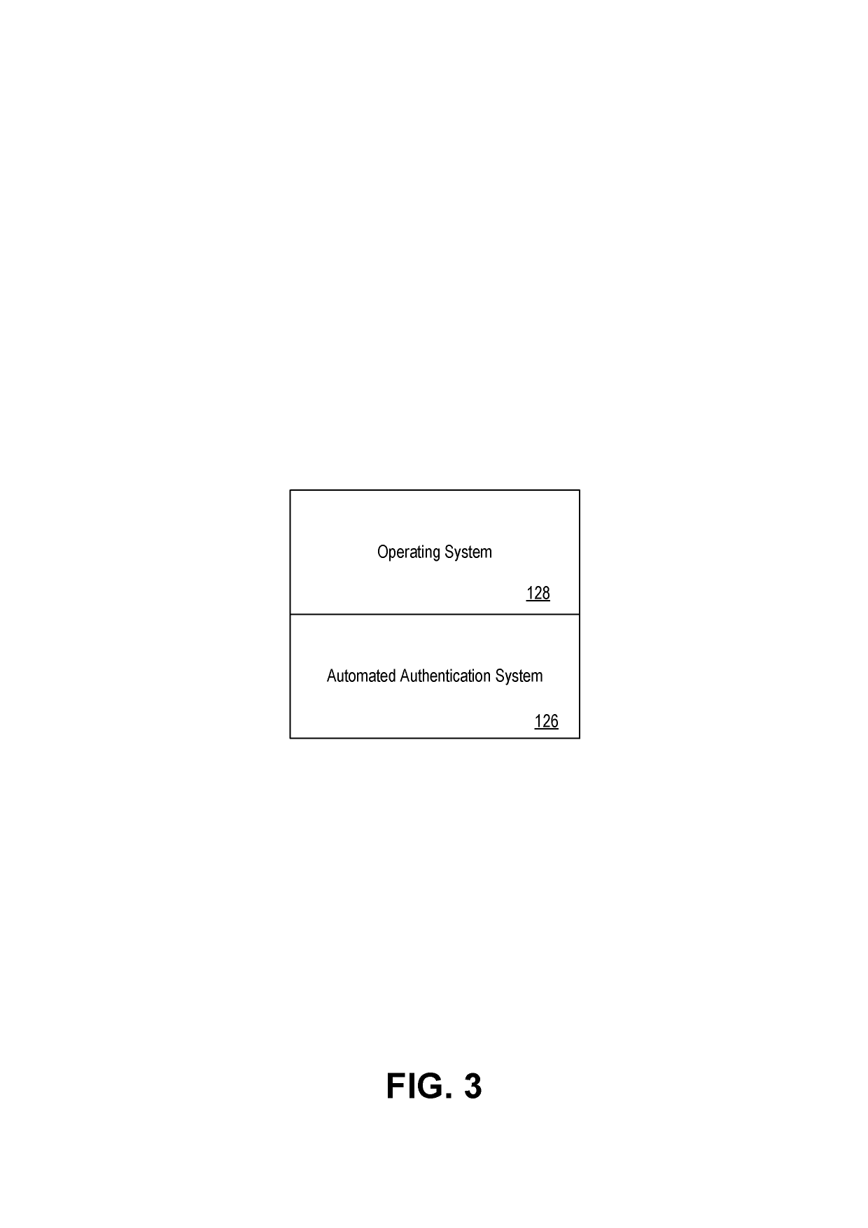

FIG. 3 depicts a simplified arrangement of software at an example computing device. The software may include an operating system 128 and application software, such as automated authentication system 126. It will be appreciated that in distributed computing environments, implementation and administration of a service such as system 126 may be distributed amongst a plurality of separate computing devices, and FIG. 3 is intended to depict a simplified logical separation between an operating system 128 and an application executing thereon for an example computing device(s).

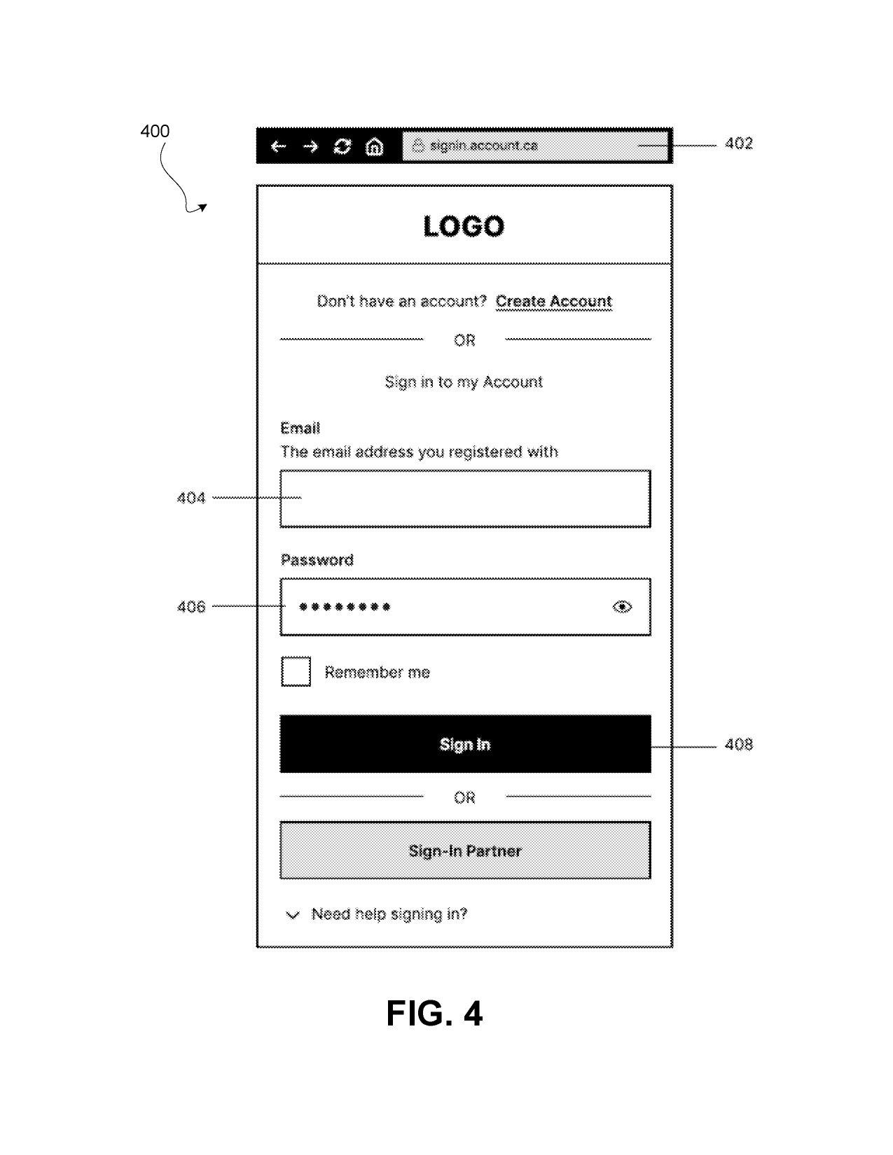

Many online services typically require users to create a user profile, including a user name and password, prior to allowing a user to access the services. FIG. 4 depicts an example graphical user interface of a login page for a service 400, in accordance with some embodiments. As depicted, the login page is a web page which has a URL 402, a user field 404, a password field 406, and a login button 408. Typically, a user may navigate to the URL of the service, enter their user name (or email address, which is often used as a substitute for a user name) in the user field 404, enter their password in password field 406, and select login button 408 (depicted as ‘Sign In’ button 408).

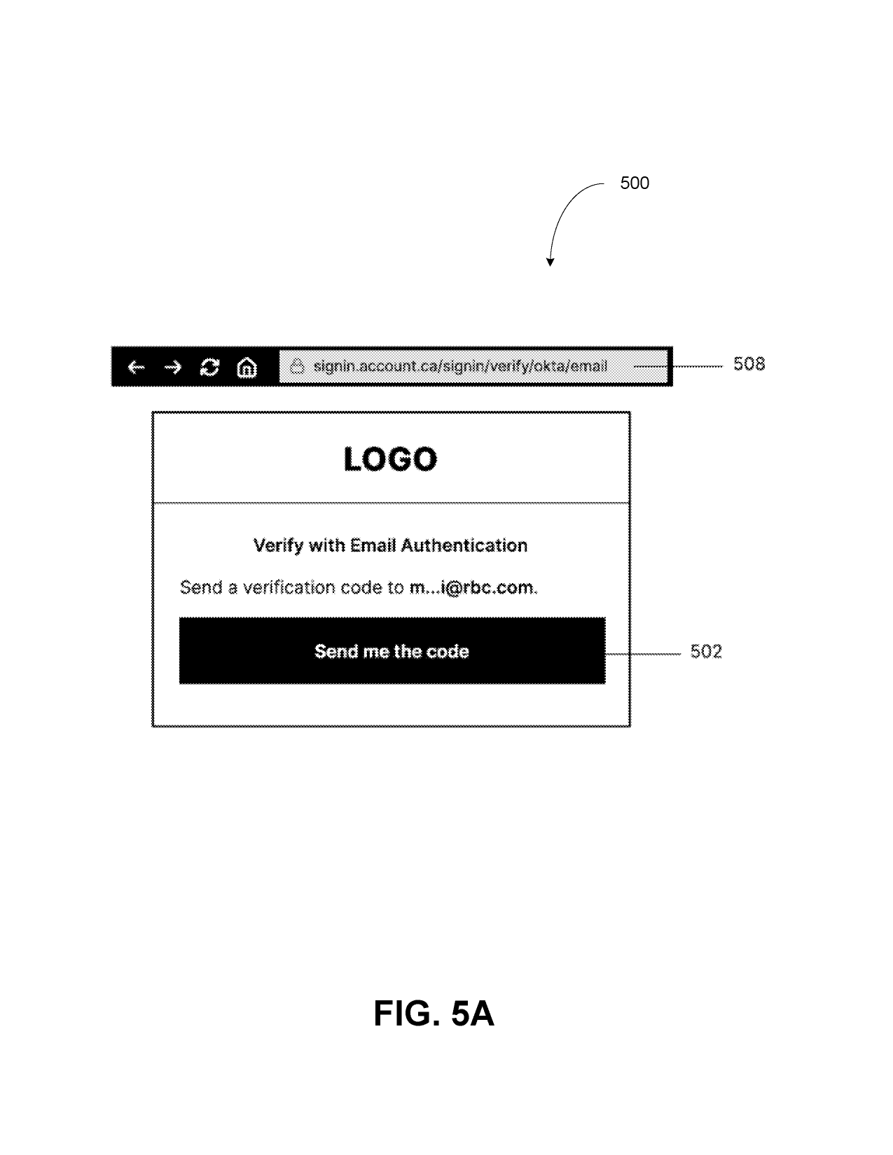

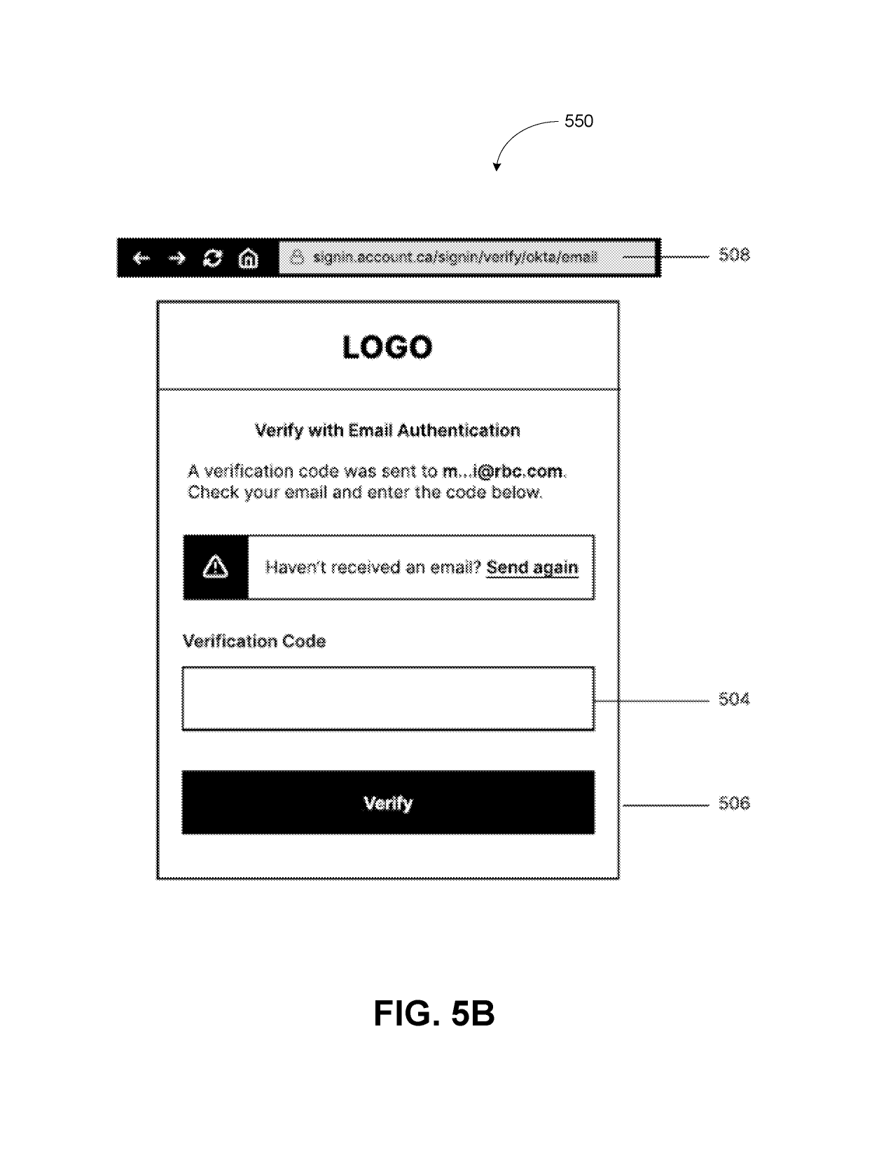

In some embodiments, a service 400 incorporating multi-factor authentication may, in response to receiving a username and corresponding password which are registered with the service, redirect the user to a verification webpage 500. FIG. 5A depicts an example graphical user interface for a verification webpage, in accordance with some embodiments. As depicted, verification webpage 500 may instruct the user to request a verification code to be delivered by activating a button 502. In some embodiments, the verification code may be delivered to the email address associated with the user’s account. In some embodiments, the verification code may be automatically delivered to the email address of the user upon attempting to log in after selecting login button 408. That is, in some embodiments, the verification email may be sent automatically, without verification web page 500 being displayed and/or without requiring the user to select the ‘send me the code’ button 502).

In some embodiments, after activating button 502 and/or otherwise sending a verification code to the user associated with the user account, the service may then redirect the user to a verification code entry web page 550, as depicted in FIG. 5B. As depicted, verification code entry web page 550 includes an entry field 504 in which the user can enter the verification code.

It should be appreciated that the URL 508 is the same in both the graphical user interfaces of FIGS. 5A and 5B, which illustrates that a user might not be able to navigate away from web pages 500 and 550 and be able to return to the same web pages using the URL 508, because the URL might not be unique to a particular web page or user session.

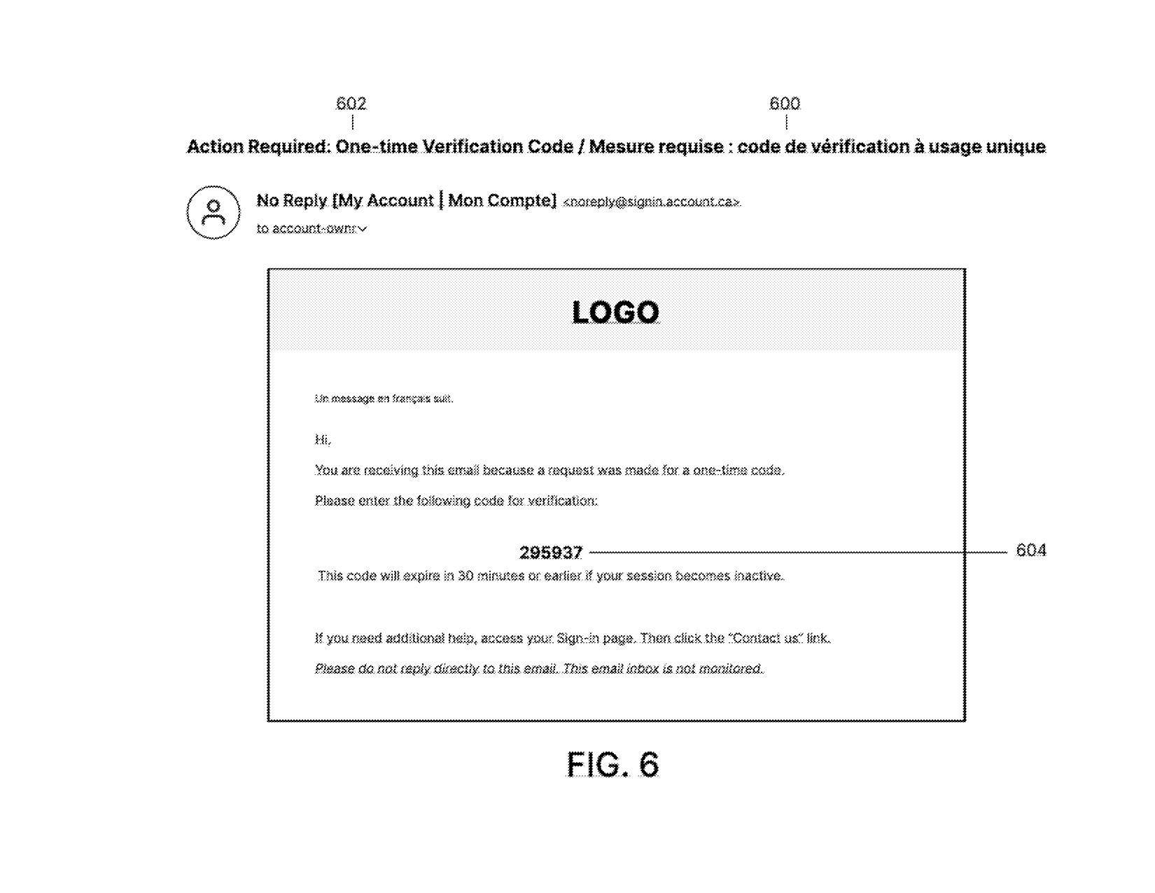

FIG. 6 depicts an example verification message 600 which might be sent to the user by the service being accessed. In some embodiments, the verification message 600 is an email. As depicted in FIG. 6, the email may include a subject line 602, and a verification code 604, among various other text string portions providing context and explanation to the user as to the reason for the message 600. Such verification messages are intended to enhance the security of the service being accessed, because they alert the legitimate user that a login attempt is being made. For example, if an unauthorized user obtains a user’s login credentials (e.g., username and password) and attempts to log in to the user’s account, the legitimate user will receive message 600, which alerts the user that a login attempt has been made to their account. In this manner, the legitimate user may be made aware of the potential security breach. For example, the legitimate user might pre-emptively change their password after learning of an unauthorized login attempt, so as to ensure that any previously obtained password by an unauthorized user is no longer valid.

Typically, after requesting the verification code or attempting to log in, the user will then navigate to their email account, retrieve the verification code 604 from message 600, and enter the verification code into code entry field 504 of verification web page 550. In some embodiments, the user may select the verification code and copy the text into the clipboard of their computing device, so as to enable copy/paste functionality rather than attempting to memorize or otherwise remember the sequence of digits in the verification code 604. Although depicted as a 6-digit numeral in FIG. 6, it should be appreciated that this is merely a simplified example. In some embodiments, a verification code might be significantly more complex. For example, a verification code might have a longer length, may contain alphanumeric characters rather than simply numerical characters, may include uppercase and lowercase characters, special characters, and the like.

Once the verification code 604 has been entered into the code entry field 504, the user may then select the ‘verify’ button 506 to complete the login process (provided the verification code entered by the user matches the code 604 sent by the authorization service and received in the verification email 600). If the verification code entered does not match the code in email 600, the system will deny access to the user.

In some embodiments, the authentication functionality may be administered by the service provider of the service being accessed by the user. For example, with reference to FIG. 1, a user of computing device 109 may be attempting to access a service provided by computing device 102. In some embodiments, data packets may be sent from computing device 108 to computing device 102 via the Internet 110, and computing device 102 may initiate the generation of web pages 500 and 550, and transmit an email message 600 which the user may access using computing device 108.

In some embodiments, the authentication functionality may be administrated by a third party authentication provider. For example, when a user at computing device 108 attempts to access services provided by service provider computing device 102, the service provider computing device 102 may then request the initiation of an authentication process by a third party authentication service provider at computing device 602. For example, web pages 500 and 550 might be provided by the third party authentication service via a web applet or web server, and the user at computing device 102 may then interact with the third party authentication service at computing device 602 for the purposes of authentication, without involving computing device 102 beyond the provision of the web applet to computing device 602. In this manner, the service provider at computing device 102 can essentially outsource the multifactor authentication services to a provider specializing in these services, rather than building and implementing its own in-house authentication protocols, which may save computing resources for the service provider.

In some embodiments, the service provider at computing device 102 may initiate an authentication request from the third party authentication service at computing device 602 (e.g., via API calls with the third party authentication provider using the user’s credentials as inputs for the API calls), and then await a response from the third party authentication service at the conclusion of the authentication process indicating the outcome (e.g., one of a “authentication successful” or “authentication failed” message).

The operation of an authentication service presents a number of technical challenges in practice. For example, as will be appreciated from FIGS. 5A and 5B, the URL 508 of the verification page might not change during the verification process, and may not be unique to a particular login session for a particular user. As such, the URL might not correspond to the particular user’s authentication session, which leads to numerous technical challenges.

For example, should the user attempt to access their email account using a web-based email client in a web browser, they might navigate away from the verification page 500. In so doing, it may be impossible to return to the verification page (because entering the URL 508 does not provide any unique session information specific to that user’s authentication session). Therefore, a user might be forced to either open a new browser window or browser tab to access their email (which requires the use of additional computing resources), or to switch windows to an email software application (e.g. Microsoft Outlook, or the like). Switching between windows may be cumbersome, particularly when a user has numerous browser tabs and applications open (a so-called “power user”), as it can be difficult to locate and return to the verification page 500 amidst a large number of other windows and/or tabs which are also open. Moreover, it is possible that the verification page 500 may inadvertently be closed whilst switching between windows (e.g., by an accidental click on a ‘close’ button while attempting to change windows or tabs, which is increasingly likely as the number of tabs open increases).

Moreover, there is often a delay between the sending of the verification message by the authentication service and the arrival of the verification message in the user’s email account. This is especially the case when the recipient email address is part of a large organization, which may use sophisticated filtering and cybersecurity systems to detect and assess potential risks with incoming communications prior to releasing the communication to its intended recipient (e.g., to prevent delivery of spam and/or malicious emails such as phishing attempts). Such delays in transmission of email and other messages may be disruptive to productivity, as the user may be required to wait until the email is received, and cannot close the verification page 500 in the meantime (as they cannot return to the verification page once they have navigated to another page, or the verification page has been closed).

Additionally, the authentication services may be provided by a third party authentication provider instead of the service provider, as described above, and therefore the authentication service provider might not be willing to cater their services to the requests of users. For example, some of the issues noted above might be efficiently ameliorated via the implementation of an application programming interface (API) by the third party authentication service provider for use with the end user (i.e., the user requesting access to the service), such that the end user could formulate the appropriately structured requests to access and obtain information from the third party authentication service. However, a third party authentication service might not be willing to develop and implement an API (whether due to lack of willingness to incur the costs associated with developing a front-end API, a deliberate decision not to implement a front-end API, or simple apathy towards the needs of end users).

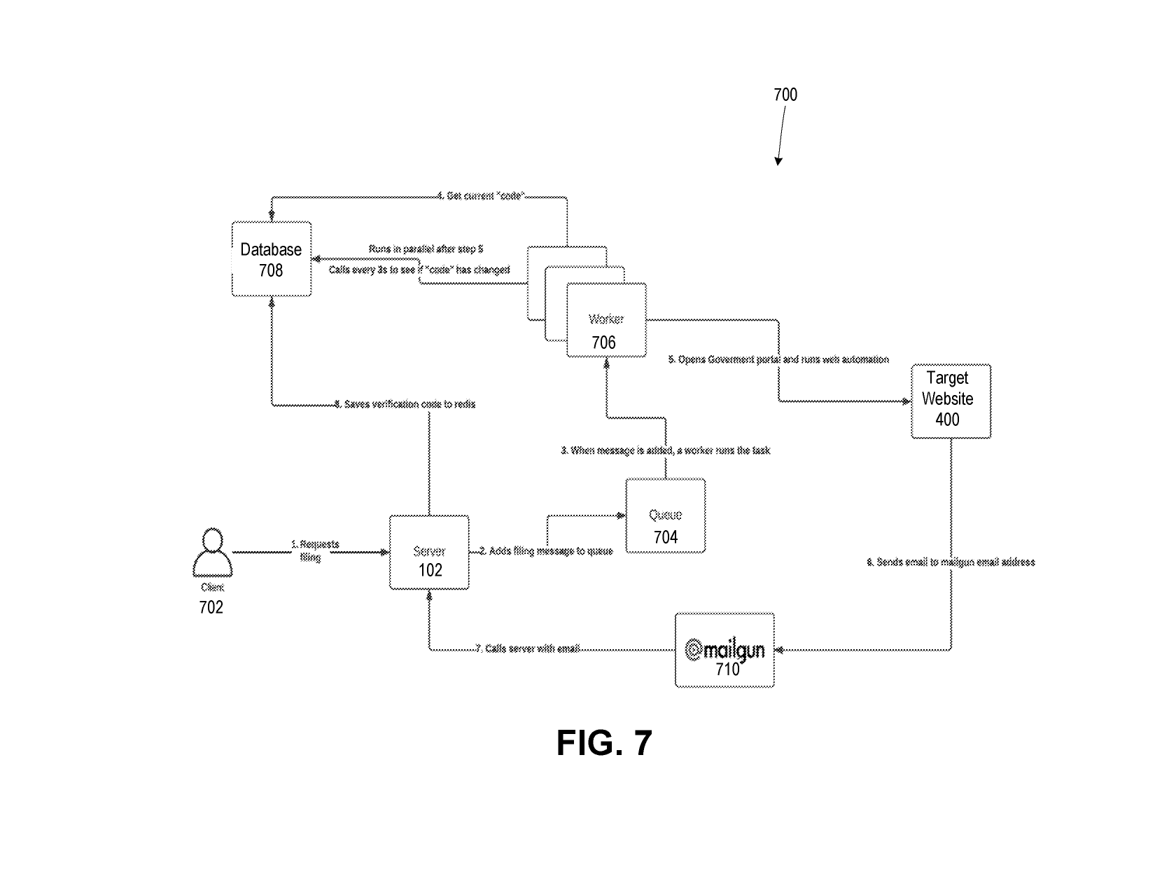

FIG. 7 is a block diagram depicting logical components of an example automated authentication system 700, in accordance with some embodiments. As depicted, system 700 may be implemented on one computing device or distributed across multiple computing devices 102, 109, 108, 106, within an organization 10 and/or external to an organization 10. In some embodiments, system 700 is configured to receive a request to utilize a service which requires multi-factor authentication to log in, and to perform the necessary operations to gain access to the requested service.

As depicted, system 700 includes a server 102 which is configured to receive a request from a user 702. In some embodiments, the request is for performing a task which requires being the requesting user to be authenticated or otherwise gaining access to a protected service (e.g., logging into a service is required to perform the task). Examples of services may include logging into a government website, accessing an account at a financial institution, and accessing virtually any other service which utilizes two-factor or multi-factor authentication to authenticate users prior to granting access.

In some embodiments, system 700 is configured to generate a request message based on the contents of the request from user 702. In some embodiments, the request message may contain information about the type of request being made, and/or any metadata associated with the request. In some embodiments, the generated request message may include one or more of the URL for the service to be accessed, the username for logging in to the service, the password associated with the username, and/or an email address for the user. In some embodiments, the request message may include a priority indicator (such as a Boolean value, or a value from a range of values to indicate the relative importance of the request message relative to other request messages).

In some embodiments, system 700 includes a message queue 704. The request message may be assigned to message queue 704. The message queue may be configured in any suitable configuration for the prioritization and performance of the request messages. For example, the message queue may be in a first in, first out (FIFO) configuration, a last-in, first-out (LIFO) configuration such as a stack, or any other prioritization system deemed suitable for the particular use case). In some embodiments, request messages which have higher prioritization indicators may be processed before request messages which have lower prioritization indicators. Likewise, request messages with a Boolean activated flag (e.g., “urgent = true”) may be processed prior to request messages which do not (e.g., “urgent = false”).

In some embodiments, request messages may be performed by computer-implemented worker agents (also referred to herein as “workers”). In some embodiments, a worker agent may be a script configured to perform a series of one or more predetermined or pre-recorded operations (similar to, for example, a macro recorder which generates programming language code representative of an observed sequence of actions from a user).

Examples of such operations may include, but are not limited to, for example, opening a web browser (e.g. by selecting a particular pixel location on a screen corresponding to an icon which opens a web browser). Further example operations may include selecting a particular location on the screen and pasting a URL stored in the clipboard to the current location of the cursor (which cursor location may, for example, correspond to the address bar of a web browser). Still further example operations may include selecting various screen locations (e.g., pixel values of screen locations corresponding to the username 404 and password fields 406, and login button 408 in a user interface 400).

It is to be understood that worker agents may be configured to perform any and all of the user actions required to request access to a service, request a verification code, and enter a verification code into the required field 504 (after retrieving the verification code) and logging in to the service. In some embodiments, a worker agent may implement a code library such as the Puppeteer Javascript library, which provides functionality to automate some or all of the browser functions outlined above.

In some embodiments, a worker agent may be configured to allow a predetermined amount of time to elapse between operations. For example, after selecting the sign-in button 408, the worker agent may be configured to wait a predetermined period of time (e.g. 2 seconds) prior to performing a subsequent operation. For example, the worker agent may be configured to wait for 2 seconds after selecting the sign-in button 408, so as to allow sufficient time for the user interface with the verification code request button 502 to load, prior to performing a subsequent action (e.g., the subsequent action may be selecting the pixel location which corresponds to the verification request button 502, so as to effect a request for a verification code).

As depicted in FIG. 7, a worker agent 706 may be assigned to a request message from queue 704. However, it should be appreciated that although FIG. 7 depicts system 700 having queue 704, it is contemplated that in some embodiments, a server 102 may assign a request message directly to a worker agent 706 rather than sending the request message to a queue.

In some embodiments, upon being assigned a request message, worker 706 is configured to obtain the string for a verification code from a predefined location in a database 708. For example, database 708 may include a key or cell location 708a which is used to store the most recently obtained verification code. In some embodiments, retrieving the most recently obtained verification code prior to a worker agent beginning the performance of the various operations associated with a login attempt may allow worker 706 to ensure that when it initiates a new access request session, worker 706 can differentiate between a newly received verification code stored at database location 708a (i.e., a verification code corresponding to the worker’s current session) and an old verification code stored in the database location 708a from a previous login attempt by a worker agent 706.

In some embodiments, after obtaining the verification code from database 708, the worker 706 may begin execution of the predetermined operations the worker agent 706 is programmed to perform. Thus, worker agent 706 may navigate to a login page for a service, enter the username and password associated with the request message, and select the sign-in button 408.

Upon selecting sign-in button 408, worker agent 706 may be configured to select the “send me the code” button 502. As noted above, in some embodiments, worker agent 706 may be configured to allow a set period of time to elapse after the “send me the code” button 502 has been activated. In some embodiments, after activating button 502, worker 706 may enter a polling loop in which worker 706 queries the location 708a of database 708 which contains the most recently obtained verification code. As noted above, prior to beginning the task associated with the assigned request message, worker 706 obtains the verification code from database 708 (which would correspond to an old verification code, for a previous access attempt). In some embodiments, worker 706 may continue polling database location 708a until the value in that database location 708a changes to a value different from the initially-obtained verification code.

In some embodiments, system 700 includes an email forwarding service 710. In some embodiments, the email forwarding service 710 may be implemented and administered internally within an organization 10. In other embodiments, the email forwarding service 710 may be implemented by a third party external to organization 10. For example, the email forwarding service 710 may be the Mailgun email delivery service operated by Mailgun Technologies, Inc, which sends, receives and tracks emails.

In some embodiments, the user’s email address (i.e., the email address which will receive the verification message (e.g., the verification email depicted in FIG. 6)) may be configured with an email forwarding service 710, such that when a new email is received, the new email may be forwarded to server 102. It will be appreciated that not all new emails received at the user’s email address will be verification emails containing a verification code. In some embodiments, email forwarding service 710 may generate and transmit a webhook (e.g., a user-defined HTTP callback) notification. In some embodiments, the webhook notification may contain the body text of the received email and the subject line text of the received email, and email forwarding service 710 may transmit the body text and subject line text of the email to server 102 for analysis.

In some embodiments, server 102 is configured to parse through the subject line and body text of the webhook notification to determine whether the received email was a verification email. In some embodiments, a verification email from a particular organization may include predictable features, such as predictable substrings of text. In some embodiments, server 102 may be configured to parse the text contents to determine whether a target phrase denoting a verification code email is contained within the email contents.

For example, using the example verification message 600 as depicted in FIG. 6, the subject line of an example received email might contain the string “One-time Verification Code”. As such, server 102 may be configured to perform further analysis of the webhook notification contents when the substring “verification code” is contained in the subject line. In some embodiments, server 102 may be configured to end the process if the subject line does not include this substring of text. It will be appreciated that the substring being searched for need not necessarily be “verification code”, and may instead be selected based on the particular wording that a particular service uses in the subject line and/or body of its verification messages. It should be further appreciated that in some embodiments, server 102 may search the body text of the webhook notification for a target phrase, rather than the subject line.

In some embodiments, when the subject line 602 and/or body of the webhook notification contains the target phrase, server 102 is configured to further parse the contents of the webhook notification to retrieve the verification code 604. In one example, server 102 may be configured to search the body text contents for a substring which is indicative of the verification code. For example, server 10 may be configured to search the body text for a string which includes only numerical characters and which appear within a certain distance of a colon (“:”) character. It will be appreciated that the particular search terms may be coded based on the expected format of the body contents of the verification message. For example, if it is known that the verification code from service 400 is numerical digits only and with a length of 6 digits, then server 102 may search the body of the email for a substring matching these conditions.

In some embodiments, conditions for identifying the email contents as being a verification email, and/or for identifying the verification code within a verification email, may be specified using “regular expression” (or “regex”) logic. Regex queries are capable of being highly specific and sophisticated (for example, a regex condition may be used to locate instances in which a lower case character is followed by one or more lower-case vowels within a text string). As such, regex expressions may offer sufficient flexibility and versatility to match the content and form of the different formats of verification codes that might be used by different services.

In some embodiments, once server 102 has identified verification code 604 (e.g. the string “295937”), server 102 may be configured to copy the verification code value and to overwrite the contents of the cell 708a containing the most recently received verification code in database 708. In this manner, the particular location 708a in the database will then contain the most current verification code 604 obtained from a verification email.

As noted above, after activating the button 502 to request a verification code, worker 706 may be in a polling loop, in which worker 706 compares the value of the verification code retrieved from location 708a in database 708, to the value which worker 706 stored prior to beginning the tasks associated with current request message session. As such, when server 102 copies the newly received verification code to location 708a of database 708, this may trigger worker 706 to exit the polling loop (because the value stored in location 708a will be different from the verification code that worker 706 pulled prior to processing the request message, thereby indicating that a new verification code has been received after initiating the current session).

Once the value in location 708a has changed, worker 706 may be configured to copy the value (which corresponds to the verification code from the newly received verification email) into the verification code field 504 (as depicted in FIG. 5B). In some embodiments, after entering the verification code 604 into verification code field 504, worker 706 may be configured to select the verify button 506. Upon entry of the verification code, access to the service may be granted and the user 702 may resume manual operation of the service they requested access for.

In some embodiments, worker 706 may be configured to end the process if a sufficient amount of time (or iterations of the loop cycle) has elapsed. For example, if a worker has been polling database 708a for over 30 seconds, worker 706 may be configured to end the loop, as it is unlikely that the code will be received prior to the login session of the service 400 timing out.

Some embodiments may automate the process of performing multi factor authentication. For example, rather than user 702 having to navigate to a page, enter their login credentials, request a verification code, and retrieve the verification code, and enter the verification code, some embodiments of system 700 may allow for the verification code 604 to be requested and obtained by worker 706 automatically, without the user having to perform any active manual actions such as switching between windows or otherwise jumping through various hoops to access the desired service.

In still further embodiments, a system may include a plurality of worker agents 706, which may each independently retrieve or be assigned request messages from queue 704. As such, it is possible for multiple different users within an organization to make access requests to server 102, with each worker agent 706 working independently to perform authentication.

In still further embodiments, system 700 may be configured to perform authentication for a plurality of different services. For example, database 708 may include a plurality of different database cell locations 708a, 708b, 708c corresponding to the most recently received verification codes for a plurality of different respective services. For example, location 708a might be used to store a verification code for logging into a financial services account, and location 708b might store a verification code for logging into a government service such as the U.S. Patent Center service 400.

Of course, the above-described embodiments are intended to be illustrative only and in no way limiting. The described embodiments are susceptible to many modifications of form, arrangement of parts, details, and order of operation. The invention is intended to encompass all such modifications within its scope, as defined by the claims.

What is claimed is:

1. A method of authenticating a user, the method comprising:
providing a database having a memory location for storing a verification code;
receiving, at a server, a request to access a service requiring multi-factor authentication;
generating, by said server, a request message based on said request to access said service;
assigning said request message to a first worker agent;
obtaining and storing, by said first worker agent, an initial verification code from said memory location of said database;
requesting, by said first worker agent, access to said service at a login page of said service, said access request comprising an email address;
detecting receipt of a message at said email address, said message including a current verification code;
determining, by said server, whether said message contains a verification code for said service;
in response to determining that said message contains said verification code for said service, storing, by said server, said current verification code in said memory location of said database;
obtaining, by said first worker agent, said current verification code from said memory location of said database;
entering, by said first worker agent, said current authentication code in a field of said login page; and
transmitting, by said first worker agent, said current verification code to gain access to said service.

2. The method of claim 1, wherein said first worker agent is configured to periodically poll said memory location of said database for a verification code.

3. The method of claim 1, wherein a period of said periodic polling is 3 seconds.

4. The method of claim 1, wherein said generated request message is added to a queue containing a plurality of requests to access said service, and wherein said assigning said request message to said first worker agent comprises assigning said request message to said first worker agent in accordance with a queuing configuration.

5. The method of claim 1, further comprising, prior to said accessing said login page of said service, obtaining and storing an initial verification code from said memory location of said database; and delaying said entering said current verification code in said field of said login page until said current verification code from said memory location of said database is different from said initial verification code.

6. The method of claim 1, further comprising generating a webhook notification based on contents of said message received at said email address.

7. The method of claim 6, wherein said webhook notification comprises text corresponding to a subject line of said message received at said email address, and text corresponding to a body of said message received at said email address.

8. The method of claim 1, wherein said message including said current verification code is an email.

9. The method of claim 1, wherein said determining whether said message contains said verification code comprises:
determining, by said server, whether a subject line or body of said message includes a target phrase.

10. The method of claim 9, wherein said target phrase is “verification code”.

11. The method of claim 9, further comprising parsing contents of said message for said current verification code when said message contains said target phrase.

12. The method of claim 1, wherein said request to access said service comprises a username and a password.

13. The method of claim 12, wherein said request to access said service comprises an email address.

14. The method of claim 1, wherein said database comprises a first dedicated memory location for storing a verification code for a first service, and a second dedicated memory location for storing a verification code for a second service.

15. A system comprising:
one or more processors; and
a computer-readable storage medium having stored thereon computer-executable instructions that, when executed by said one or more processors, cause said one or more processors to perform a method of authenticating a user, the method comprising:
providing a database having a memory location for storing a verification code;
receiving, at a server, a request to access a service requiring multi-factor authentication;
generating, by said server, a request message based on said request to access said service;
assigning said request message to a first worker agent;
obtaining and storing, by said first worker agent, an initial verification code from said memory location of said database;
requesting, by said first worker agent, access to said service at a login page of said service, said access request comprising an email address;
detecting receipt of a message at said email address, said email address, said message including a current verification code;
determining, by said server, whether said verification message contains a verification code;
in response to determining that said message contains said verification code, storing, by said server, said current verification code in said memory location of said database;
obtaining, by said first worker agent, said current verification code from said memory location of said database;
entering, by said first worker agent, said current authentication code in a field of said login page; and
transmitting, by said first worker agent, said current verification code to gain access to said service.

16. A non-transitory computer-readable storage medium having stored thereon computer-executable instructions that, when executed by one or more processors, cause said one or more processors to perform a method of authenticating a user, the method comprising:
providing a database having a memory location for storing a verification code;
receiving, at a server, a request to access a service requiring multi-factor authentication;
generating, by said server, a request message based on said request to access said service;
assigning said request message to a first worker agent;
obtaining and storing, by said first worker agent, an initial verification code from said memory location of said database;
requesting, by said first worker agent, access to said service at a login page of said service, said access request comprising an email address;
detecting receipt of a message at said email address, said message including a current verification code;
determining, by said server, whether said verification message contains a verification code;
in response to determining that said message contains said verification code, storing, by said server, said current verification code in said memory location of said database;
obtaining, by said first worker agent, said current verification code from said memory location of said database;
entering, by said first worker agent, said current verification code in a field of said login page; and
transmitting, by said first worker agent, said current verification code to gain access to said service.
